(19) United States
(12) Patent Application Publication
(10) Pub. No.: US 2018/0081104 A1
(43) Pub. Date: Mar. 22, 2018

(54) ILLUMINATION DEVICE

(71) Applicant: Dara Fiona RIGAL, London (GB)

(72) Inventor: Dara Fiona RIGAL, London (GB)

(21) Appl. No.: 15/708,152

(22) Filed: Sep. 19, 2017

(30) Foreign Application Priority Data
Sep. 19, 2016 (GB) 1615895.8

(51) Int. Cl. F21V 8/00; F21V 3/00; F21V 17/06

(52) U.S. Cl. CPC G02B 6/001; G02B 6/0006; F21Y 2115/10; F21V 17/06; F21V 3/00

(57) ABSTRACT

The present invention provides an illumination device (100) that utilises the internal reflection properties of optical fibre preforms. The illumination device (100) comprises a light source (402) and a preform or a preform offcut (126). An optical fibre preform is a glass tube having a core made of a soot that has been deposited on the inside of the glass tube by a process of vapour deposition, wherein the core has a higher refractive index than the surrounding glass. This preform is then formed into an optical fibre by a process called “pulling”, wherein the ends of preform are cut off and discarded. Because of the difference in refractive index between the core and the surrounding glass of the preform offcut (126), the core is illuminated when a light source (402) directs a beam of light into the preform offcut (126), causing it to glow brightly.

### RELATED APPLICATION

This application claims the benefit of priority of United Kingdom Patent Application No. 1615895.8 filed Sep. 19, 2016, the contents of which are incorporated herein by reference in their entirety.

### FIELD AND BACKGROUND OF THE INVENTION

Embodiments of the present invention relate to an illumination device and a method of manufacture thereof. In particular, the present invention relates to an illumination device constructed from the by-products produced when forming optical fibres.

Optical fibres are flexible transparent fibres that are used to transmit light over large distances, most commonly used in the field of telecommunications. Typically, optical fibres are made of a transparent glass core surrounded by a cladding material, wherein the cladding material has a lower index of refraction than the core. As a consequence of this structure, the light is kept within the core by a phenomenon known as total internal reflection which causes the fibre to act as a wave guide.

To make the optical fibres, glass tubes made from materials such as silica, fluoride, phosphate and chalcogenide are doped with a gas vapour to produce a preform. The preform has large diameter and a carefully controlled refractive index profile. Typically, the preform has a circular cross-section, but may have a different shape depending on what the optical fiber is to be used for. The preform is commonly made by three different chemical vapour deposition methods; inside vapour deposition, outside vapour deposition, and vapour axial deposition. During inside vapour deposition, the vapour is deposited as a soot on the inside of the glass tube which will eventually become the core of the optical fibre, whilst the glass tube becomes the cladding. The preform, which is typically around lm in length, then undergoes a process known as “pulling” in which the preform is formed into a long, thin optical fibre with drip-shaped formations at their ends. This pulling process is capable of producing optical fibres that are many kilometres in length.

After this pulling process, the drip-shaped ends of the preform are cut off and discarded. With large scale production of optical fibres, significant volumes of these preform offcuts are produced and disposed of. This is particularly a problem as the offcuts are not biodegradable and can therefore not be disposed in an environmentally friendly way. Furthermore, as the offcuts include the soot from the vapour deposition, the offcuts themselves cannot be melted down and reused to make further optical fibres.

Therefore, it is desirable that a use be found for the ends of the preform once they have been cut off from the fully formed optical fibre. In doing this, the amount of waste produced during the mass production of optical fibres can be reduced.

### SUMMARY OF THE INVENTION

The present invention provides an illumination device that utilises the internal reflection properties of optical fibre preforms. The illumination device comprises a light source and a dispersing element having more than one refractive index such as an optical fibre preform or a preform offcut. The preform is a glass tube having a core made of a soot that has been deposited on the inside of a glass tube by vapour deposition, wherein the core has a higher refractive index than the surrounding glass. This preform is then formed into an optical fibre by a process called “pulling”, wherein the ends of preform are cut off and discarded.

Because of this difference in refractive index between the core and the surrounding glass of the preform offcut, the core is illuminated when the light source directs a beam of light into the preform offcut, causing it to glow brightly.

According to a first aspect of the invention, there is provided an illumination device comprising an optical fibre preform offcut, and a light source arranged to direct a light into an end of the optical fibre preform offcut.

The device may further comprise a support means for holding the optical fibre preform offcut in relation to the light source.

Additionally, the device may comprise a housing in which the optical fibre preform offcut and the light source are contained, wherein the housing comprises the support means.

The housing may comprise a base portion, a lid portion, and one or more walls extending therebetween. At least a part of the one or more walls may be transparent, for example, at least a part of the one or more walls may be made of glass or a transparent plastic. It will be appreciated that any suitable transparent material may be used.

The light source may be housed within the base portion, the optical fibre preform offcut being suspended from the lid portion such that the longitudinal axis of the optical fibre preform offcut is in alignment with the light source.

The support means may comprise a first gasket arranged to couple the optical fibre preform offcut to the housing.

The support means may further comprise an internal conduit arranged to at least partially encase the optical fibre preform offcut, the internal conduit being coupled at a first point to the lid portion and coupled at a second point to the optical fibre preform offcut. The internal conduit may be coupled at the first point to the lid portion by a second gasket and coupled at the second point to the optical fibre preform offcut by a third gasket.

In some arrangements, the internal conduit may be made of a transparent material, for example, glass or a transparent plastic. The base portion and the lid portion may be made of at least one of: brass, copper, stainless steel, wood, cork or plastic

In some arrangements, the housing may have a length of up to about 100 cm. However, it will be appreciated that the housing may be of any suitable size from about 20 cm up to about 200 cm.

In another alternative arrangement, the support means may comprise a base in which the light source is contained, and a frame connected to the base, wherein the frame is secured to the preform offcut at one or more locations.

The light source may a light emitting diode (LED), or any other suitable device for emitting a beam of light.

According to a second aspect of the invention, an illumination device is provided comprising a light source, and a dispersing element having a plurality of refractive indices spaced apart from the light source and which receives all of the light from the light source.

The light source may comprise a source of illumination and a shroud for directing the light.

In some arrangements, the dispersing element may be a crystal.

According to a third aspect of the invention, an illumination device is provided comprising an optical fibre preform offcut, and a light source arranged to output a light from within the optical fibre preform offcut.

According to a fourth aspect of the invention, a system is provided comprising a plurality of illumination devices as outlined above.

### BRIEF DESCRIPTION OF THE SEVERAL VIEWS OF THE DRAWINGS

Further features and advantages of the present invention will become apparent from the following description of embodiments thereof, presented by way of example only and by reference to the drawings, wherein:

FIG. 1 shows a perspective view of an illumination device according to a first embodiment of the present invention;

FIG. 2 shows a further perspective view of the illumination device according to the first embodiment of the present invention;

FIG. 3 is an exploded view of part of the illumination device according to the first embodiment of the present invention;

FIG. 4 is an exploded view of the base of the illumination device according to the first embodiment of the present invention;

FIG. 5 is an exploded view of the lid of the illumination device according to the first embodiment of the present invention;

FIG. 6 is a cross-sectional view of the illumination device according to the first embodiment of the present invention;

FIG. 7 is a cross-sectional view of the base shown in FIG. 4;

FIG. 8 is a cross-sectional view of the lid shown in FIG. 5;

FIG. 9 is a cross-sectional view of the illumination device according to a second embodiment of the present invention; and

FIG. 10 is a cross-sectional view of the illumination device according to a third embodiment of the present invention.

### DESCRIPTION OF SPECIFIC EMBODIMENTS OF THE DRAWINGS

As discussed above, the drip-shaped ends of the preform worked on during the production of optical fibres are cut off after the pulling process. As these preform offcuts are not yet fully formed optical fibres, the core is not fully formed to the extent that total internal reflection occurs. That is to say, the difference in refractive index between the core formed from the soot deposited on the inside of the glass tube and the surrounding glass tube is not great enough that all of the light is trapped within the core when light is shone into the preform offcut. However, as the core does have a higher refractive index than the surrounding glass, some of that light is trapped within the core, whilst some light escapes out through the surrounding glass cladding. This results in an illuminating effect, particularly within the core. The present invention utilises the refractive properties of the preform offcut to provide an illumination device, as will now be described.

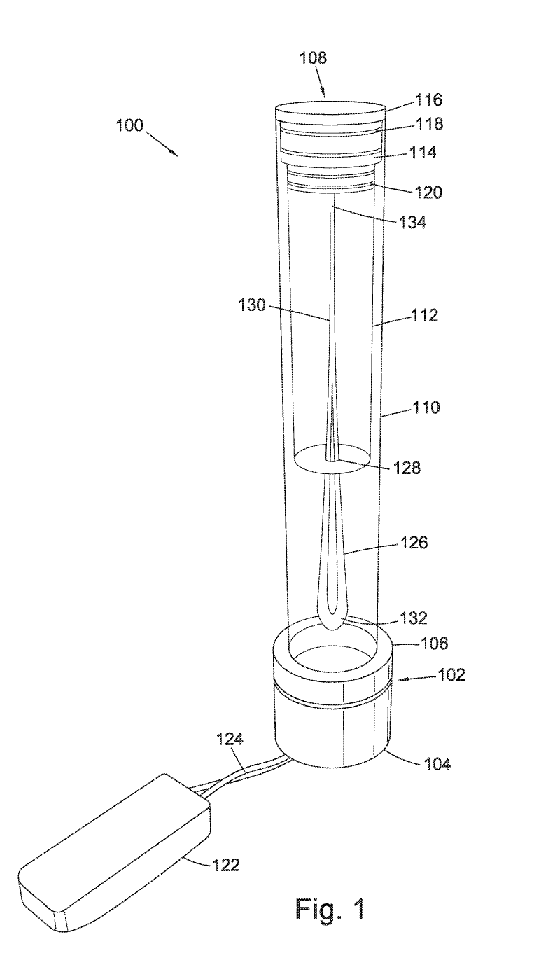

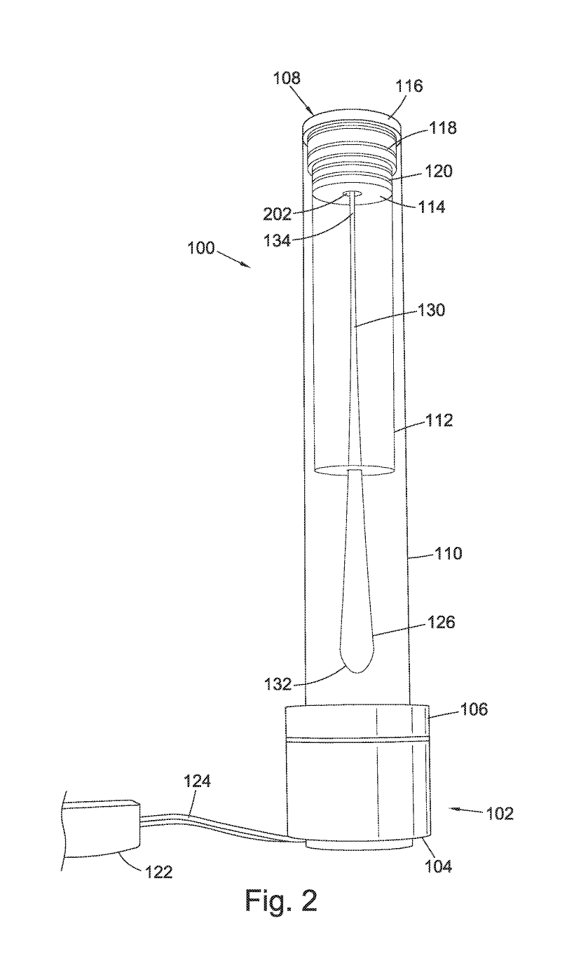

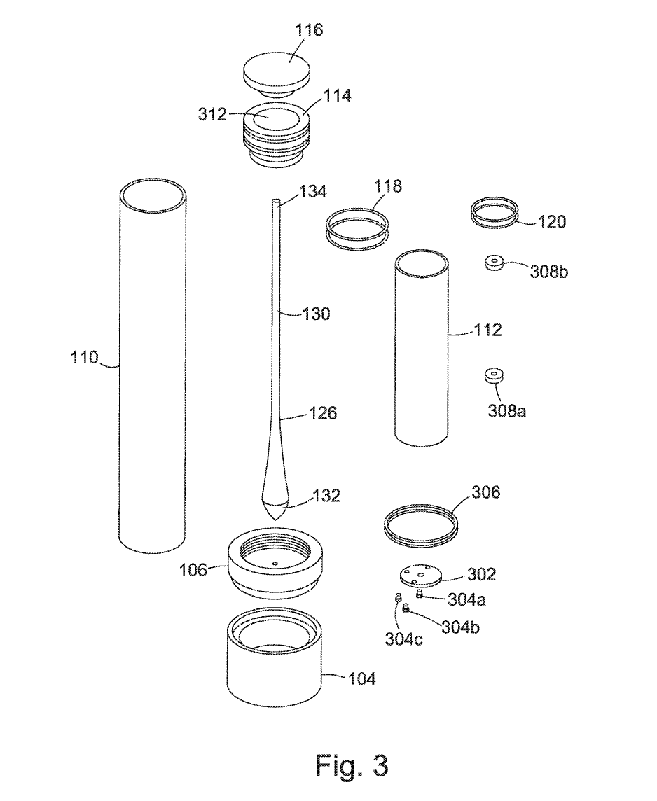

FIGS. 1 to 3 illustrate an illumination device 100 according to the present invention. The device 100 comprises a base 102 that is coupled to an electrical power source 122 or some means for connecting to an electrical power source. The device 100 further comprises an optical fibre preform offcut 126 that is encased within a transparent outer tube 110 and suspended above the base 102 by means of a lid arrangement 108. A light source (not shown) is encased within the base 102 so as to direct a beam of light into the preform offcut 126.

The refractive properties of the preform offcut 126 cause the light to be dispersed, thereby producing an illuminating effect.

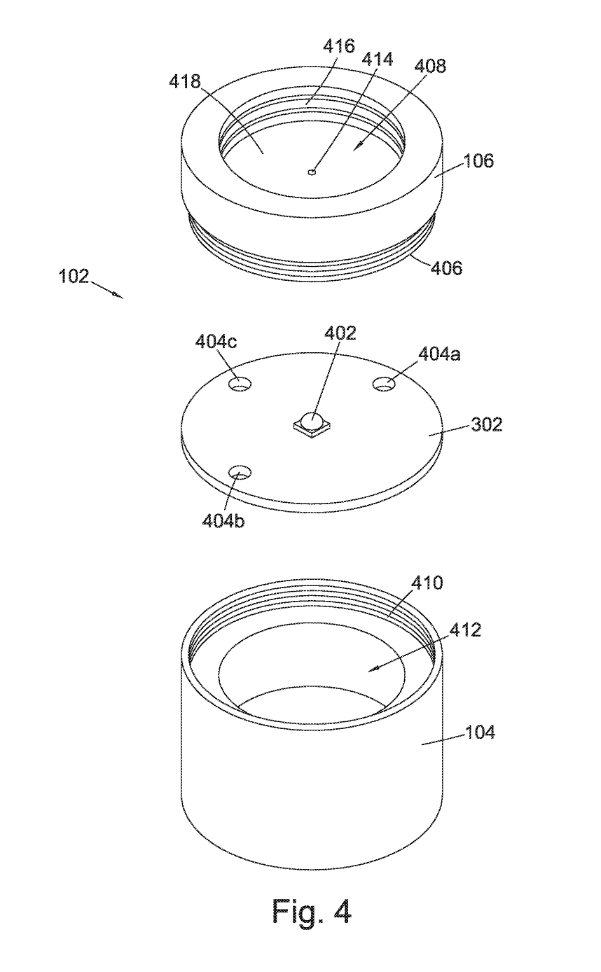

Describing the device 100 now in more detail, the base 102 is formed of a lower part 104 and an upper part 106, as shown further in FIGS. 4, 6 and 7. The upper part 106 comprises an external threaded portion 406 that screws into a cooperating internal threaded portion 410 located on the lower part 104 to secure the two parts 104, 106 together. As described above, the base 102 also contains a light source 402 that is connected by some means to the electrical power source 122. In this example, the light source 402 is a light emitting diode (LED) mounted on a printed circuit board (PCB) 302. A light source 402 such as an LED has various advantages including, but not limited to, a compact size, lower energy consumption, longer lifetime and overall physical robustness. As LEDs are generally operated at low currents and low temperatures, there is very limited wear and tear that can cause the LED to fail altogether. However, whilst an LED is used in this example, it will be appreciated that any suitable light source may be used. The PCB 302 is positioned within a cavity 412 of the lower part 104 and held in place by any suitable means, for example, by a plurality of screws 304a-c arranged to cooperate with a plurality of holes 404a-c in the PCB 302. The cord 124 of the electrical power source 122 is fed into the lower part 104 via an opening 600 in the bottom of the base 102 and connected to the PCB 302.

When an electrical power is delivered to the PCB 302, it causes the LED 402 to emit a beam of light that is directed through a small aperture 414 or shroud located in the base 418 of the upper part 106. The aperture 414 is small so as to provide a focused beam of light that points directly into the preform offcut 126. It is the internal reflection within the preform offcut 126 that then causes this beam of light to spread outwards through the sides of the preform offcut 126 and produce the illuminating effect. As such, whichever light source is used, it is important that the light source is shrouded in some way to ensure that only a concentrated beam of light is emitted from the light source. In this example, the LED 402 is encased within the base 102, but the light source may be encased within a body of any sort with the preform offcut 126 suspended above or below by some means.

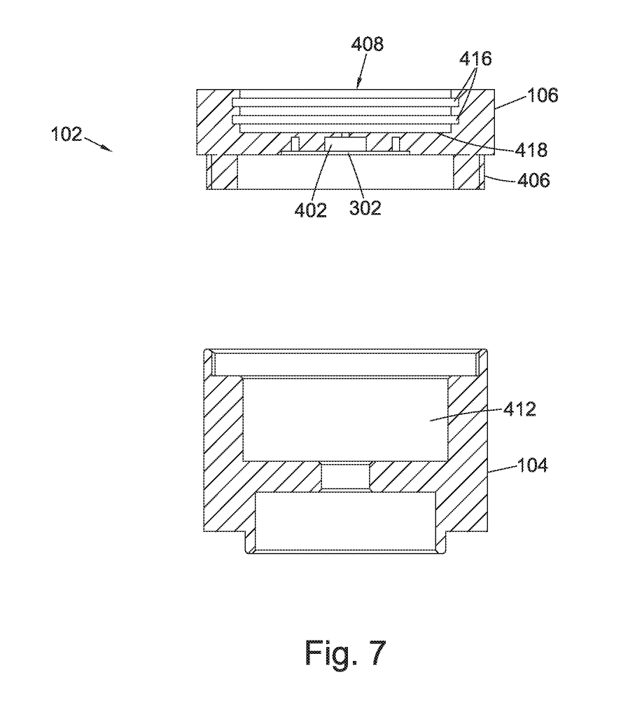

Referring back to FIGS. 1 to 3, the upper part 106 is coupled to the lower end of the transparent outer tube 110. In this example, a gasket 306 provides a compression fit which holds the outer tube 110 in place, however, the upper part 106 and the transparent tube 110 may be coupled together such that they are firmly held in place by any other suitable means. In this example, the gasket 306 is a silicone O-ring 306 that sits within a cavity 408 of the upper part 106, wherein the cavity 408 has a ridged or grooved portion 416 for receiving the O-ring 306, as shown in more detail in FIGS. 4 and 7. The outer tube 110 is made of a material such as glass or clear plastic, or any suitable transparent material through which light can easily travel.

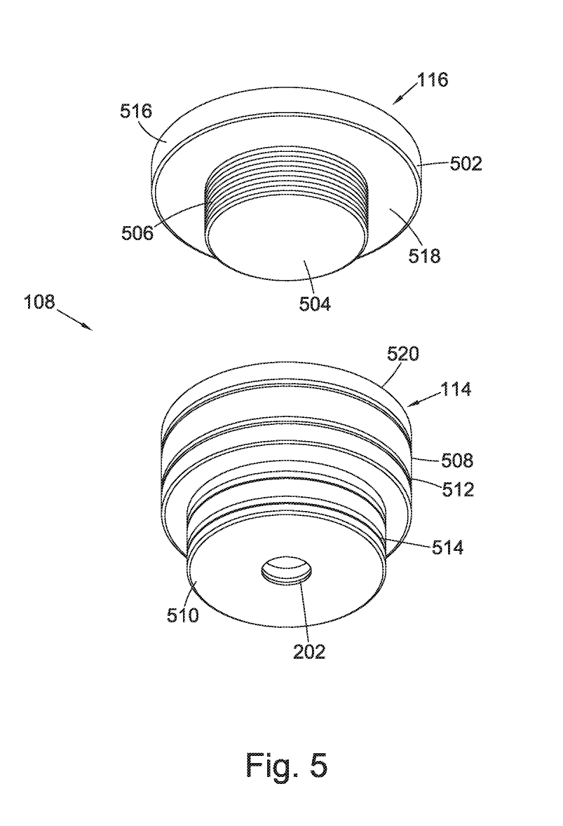

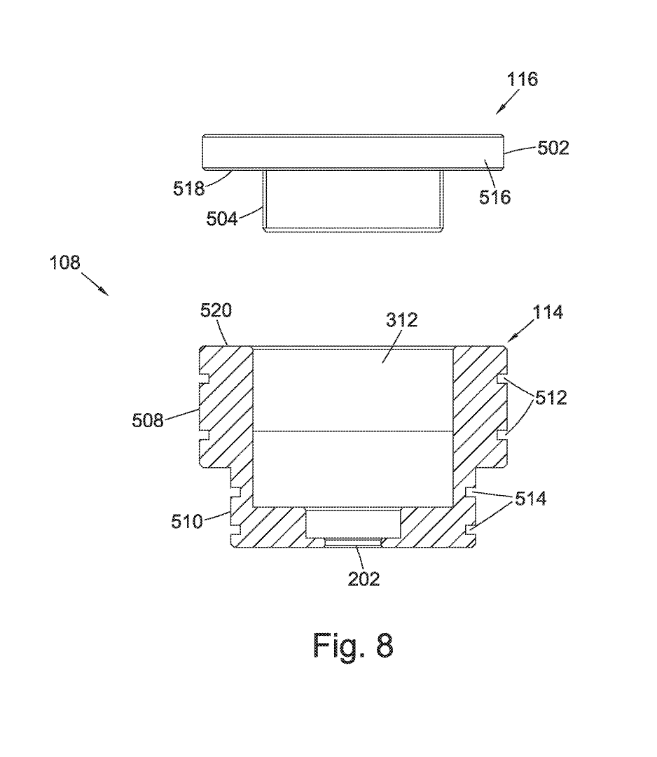

The outer tube 110 is capped at the top by the lid 108. Both the base 102 and the lid 108 may be made of any suitable material including, but not limited to, brass, copper, stainless steel and other metals, wood, cork or plastic. The lid 108 is formed of a lid top 116 and a lid body 114, as shown in FIGS. 5, 6 and 8. The lid body 114 is a cylindrical component formed of two portions, the first portion 508 having a larger diameter than the second portion 510. The lid body 114 is housed within the top of the outer tube 110 such that the first portion 508 plugs the end of the outer tube 110, and is held in place by some suitable means, for example, a gasket 118 that sits around the circumference of the first portion 508 of the lid body 114 to thereby seal the junction between the outer tube 110 and the lid 108. To ensure a secure fit, the first portion 508 of the lid body 114 may comprise a ridged or grooved portion 512 for receiving the gasket 118. The lid top 116 also comprises two portions, the upper portion 502 having a larger diameter than the lower portion 504 to form a lip 516. The lower portion 504 comprises an external thread 506 that screws into a cavity 312 of the lid body 114 such that at least part of the underside 518 of the lip 516 sits flush against the top 520 of the first portion 508 of the lid body 114 and the outer tube 110, thereby sealing the top of the device 100. As such, the base 102, the lid 108 and the outer tube 110 are coupled together to form a housing.

The second portion 510 of the lid body 114 is coupled to a transparent inner tube 112 such that the second portion 510 plugs one end of the inner tube 112, for example, by a further gasket 120 that sits around the circumference of the second portion 510 to thereby couple the lid body 114 and the inner tube 112 together such that they are firmly held in place. To ensure a secure fit, the second portion 510 of the lid body 114 may comprise a ridged or grooved portion 514 for receiving the gasket 120. The inner tube 112 is made of a material such as glass or clear plastic, or any suitable transparent material through which light can easily travel.

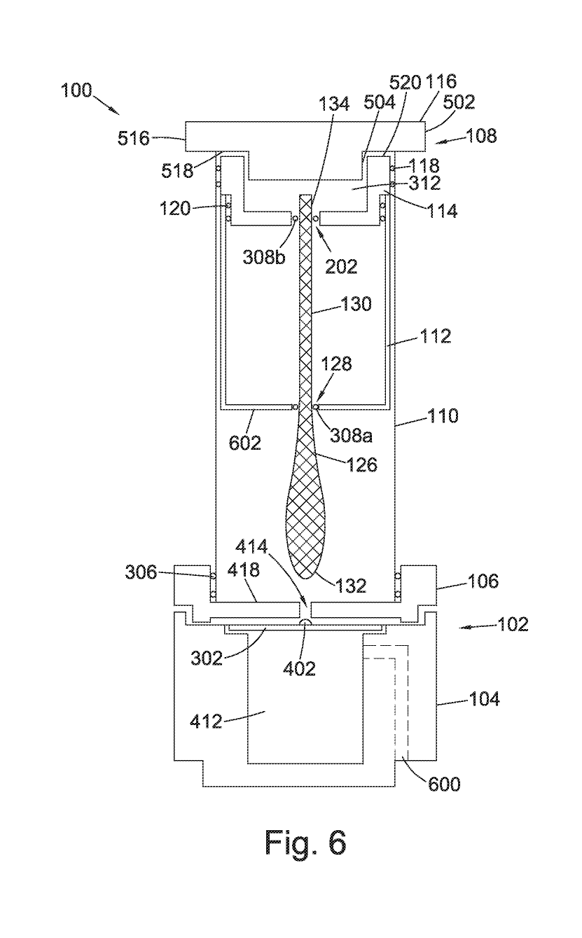

As shown in FIG. 6, the inner tube 112 has a bottom plate 602 which comprises an aperture 128 at its centre. The aperture 124 is arranged to receive the elongate body portion 130 of a preform offcut 126, the aperture 128 comprising a gasket 308a to secure the preform offcut 108 in place. To further secure the preform offcut 126 within the device 100, the upper end 134 of the preform offcut 126 is received by a further aperture 202 located in the base of the lid body 114, which also includes a gasket 308b to couple the preform offcut 126 and the lid body 114 together such that they are held in place. In doing this, the lid body 114 and the inner tube 112 act as a support means for holding the preform offcut 126 above the base 102 such that the rounded end 132 of the preform offcut 126 is positioned directly above the aperture 414 in the upper part 106 of the base 102. As such, the longitudinal axis of the preform offcut 126 is aligned with the beam of light emitted from the LED 402. Consequently, when the LED 402 is turned on, the beam of light emitted therefrom is directed through the aperture 414 in the base 102 and up into the rounded end 132 of the preform offcut 126, thereby illuminating the preform offcut 126. As described above, the refractive index of the glass due to the soot in the core of the preform offcut 126 is higher than the surrounding glass. Therefore, a portion of light is trapped within the core causing it to glow brightly.

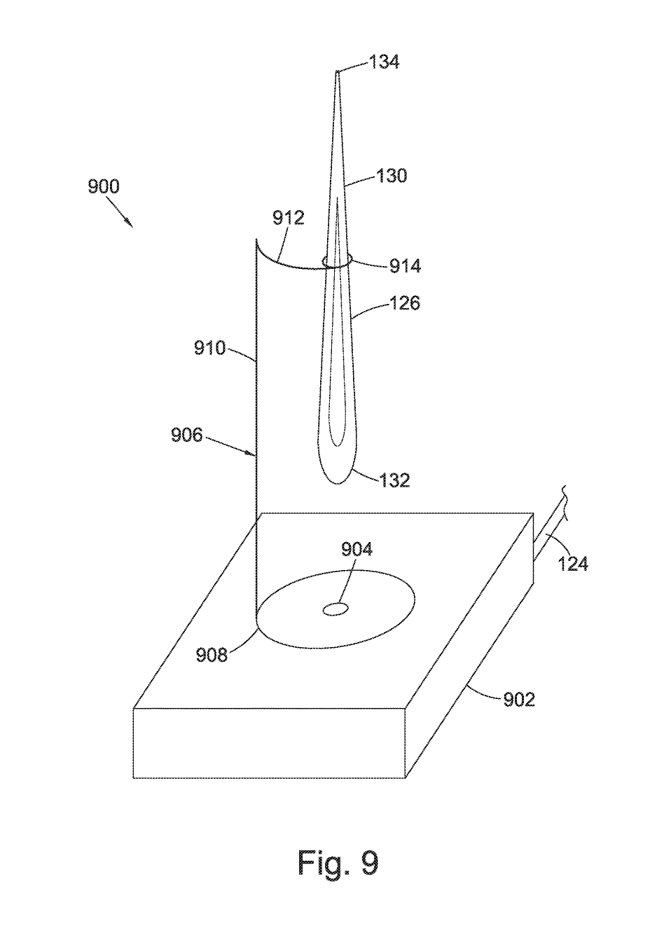

An alternative device 900 is shown by FIG. 9, in which the preform offcut 126 is held above a light source 904 by means of a rigid armature 906. Here, the light source 904 is mounted within a base 902, upon which the armature 906 is affixed. The armature 906 is formed of an armature base 908 that is attached to the base 902, a strut 910 extending vertically from the base 902, and a support arm 912 located at the end of the strut 910. The support arm 912 has a loop 914 formed in its end which is wrapped around the elongate body portion 130 of the preform offcut 126, thereby holding the preform offcut 126 over the base 902 such that the rounded end 132 of the preform offcut 126 is positioned directly above the light source 904. Preferably, the armature 906 is made of a metal wire.

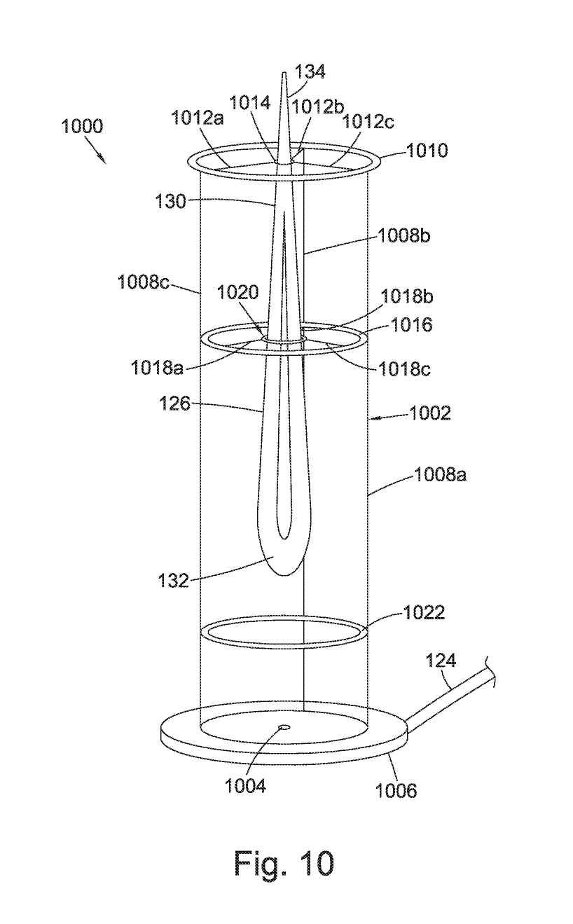

In another alternative device 1000, illustrated by FIG. 10, the preform offcut 126 is supported by a metal frame or cage 1002. The frame 1002 comprises a light source 1004 mounted within a base 1006, the frame 1002 having a plurality of struts 1008a-c, preferably three or more, extending vertically from the base 1006. The ends of the struts 1008a-c are connected to a top hoop 1010, the top hoop 1010 having a plurality of radial spokes 1012a-cthat meet at a central hub 1014. The top hub 1014 is arranged to sit around the upper end 134 of the preform offcut 126. Along the length of the struts 1008a-c, towards the mid-section of the frame 1002, a second hoop 1016 is connected. The second hoop 1016 comprises a plurality of radial spokes 1018a-c that meet at a second central hub 1020. The second hub 1020 is arranged to sit around the elongate body portion 130 of the preform offcut 126 to form a support point and thereby hold the preform offcut 126 above the base 1004 such that the rounded end 132 is positioned directly above the light source 904. A third hoop 1022 may also be connected to the struts 1008a-c to improve the structural integrity of the frame 1002. The hoops 1010, 1016, 1022 of this arrangement may be connected to the struts 1008a-c by any suitable means, for example, by welding the edges of the hoops 1010, 1016, 1022 to the struts 1008a-c.

In all of the arrangements described herein, the dimensions of the device 100, 900, 1000 will depend primarily on the size of the preform offcut 126 being used, however, the height of the device may be anything from about 20 centimetres up to about 200 centimetres.

Various modifications, whether by way of addition, deletion and/or substitution, may be made to all of the above described embodiments to provide further embodiments, any and/or all of which are intended to be encompassed by the appended claims.

For example, in the arrangement shown in FIGS. 1 to 8, the light source 402 may be located in the lid 108 such that it is held above the preform offcut 126, the beam of light being directed downwards into the preform offcut 126.

In the arrangement shown in FIGS. 1 to 10, the preform offcut 126 is positioned such that the rounded end 132 sits just above the base 102, 902, 1006, however, it will be appreciated that the preform offcut 126 may be rotated by 180° such that the upper end 134 is directly above the base 102, 902, 1006. The light from the LED 402 is then directed into the elongate body 130 of the preform offcut 126 either from above or below, resulting in the same illuminating effect.

Additionally, in the arrangements described herein, the device 100, 900, 1000 comprises a preform offcut 126 formed after the “pulling” process during the production of optical fibres. In alternative arrangements, the device 100, 900, 1000 may comprise a length of preform that has not yet undergone any “pulling”. Alternatively, the device 100, 900, 1000 may utilise any piece of glass, preferably having a plurality of refractive indices. As such, the device 100, 900, 1000 may comprise a light source, and any dispersing element having a plurality of refractive indices, wherein the dispersing element is spaced apart from the light source but arranged to receive all of the light from the light source.

In the arrangement illustrated by FIGS. 1 to 8, the base 102, the lid 108 and the outer tube 110 have a circular profile, and therefore form a cylindrical housing in which to house the light source 402 and the preform offcut 126. However, it will be appreciated that the device 100 may be any shape. For example, the base 102 and the lid 108 may have a square profile, with the outer tube 110 being a rectangular tube. Alternatively, the base 102 and the lid 108 may have a triangular profile, with the outer tube 110 being a triangular prism. Similarly, the frame 1002 shown in FIG. 10 may have a profile of any shape. For example, the frame 1012 may comprise four struts connected by square shaped hoops to form a square profile.

In the arrangement shown by FIGS. 1 to 8, only a proportion of the outer tube 110 may be made of transparent material. For example, in cases where the outer tube 110 is a rectangular tube, only two walls of the rectangular tube may be made of a transparent material, whilst the other two walls may be made of some other suitable non-transparent material.

In another alternative arrangement, the device 100 may not include the inner transparent tube 112, with the preform offcut 126 being suspended above the base 102 solely by means of the lid arrangement 108. That is to say, the preform offcut 126 may only be anchored to the rest of the device 100 at one point.

In the example described by FIGS. 1 to 8, the preform offcut 126 is housed within a casing formed of the base 102, lid 108 and outer tube 110, with a beam of light directed into the preform offcut 126 by means of an LED 402 located within the base 102, or alternatively the lid 108. However, to achieve the illuminating effect, the preform offcut 126 may be suspended by any means above or below a light source shrouded or encased within a body such that all of the light is directed into the preform offcut 126. For example, the preform offcut 126 may be suspended above or below a light source by a wire or string. In this respect, a light installation or lighting system may be provided by a plurality of optical fibre preforms or preform offcuts suspended above or below a light source.

Additionally, in the arrangement shown in FIGS. 1 to 8, the longitudinal axis of the preform offcut 126 is aligned with the beam of light emitted from the LED 402, however, it will be appreciated that the same illuminating effect will be achieved whichever angle the beam of light is pointing relative to the longitudinal axis of the preform offcut 126. For example, the beam of light may be directed into the side of the preform offcut 126, that is, the beam of light is perpendicular to the longitudinal axis of the preform offcut 126.

Alternatively, the source of illumination may be located within the preform offcut 126. For example, an LED, optical fibre or any other suitable light source may be embedded in the core of the preform offcut 126 and/or the surrounding glass cladding.

In the arrangement shown in FIGS. 1 to 6, the light source 402 is encased within the base 102, the base having an aperture 414 for directing the beam of light into the preform offcut 126. However, it will be appreciated that the light source may be shrouded in any suitable way, provided the light is directed into the preform offcut 126.

What is claimed is:

1. An illumination device, comprising:
an optical fibre preform offcut; and
a light source arranged to direct a light into an end of the optical fibre preform offcut.

2. A device according to claim 1, further comprising a support means for holding the optical fibre preform offcut in relation to the light source.

3. A device according to claim 2, further comprising a housing in which the optical fibre preform offcut and the light source are contained, wherein the housing comprises the support means.

4. A device according to claim 3, wherein the housing comprises a base portion, a lid portion, and one or more walls extending therebetween.

5. A device according to claim 4, wherein at least a part of the one or more walls is transparent.

6. A device according to claim 4, wherein at least a part of the one or more walls is made of glass or a transparent plastic.

7. A device according to claim 4, wherein the light source is housed within the base portion, and wherein the optical fibre preform offcut is suspended from the lid portion such that the longitudinal axis of the optical fibre preform offcut is in alignment with the light source.

8. A device according to claim 3, wherein the support means comprises a first gasket arranged to couple the optical fibre preform offcut to the housing.

9. A device according to claim 8, wherein the support means further comprises an internal conduit arranged to at least partially encase the optical fibre preform offcut, the internal conduit being coupled at a first point to the lid portion and coupled at a second point to the optical fibre preform offcut.

10. A device according to claim 9, wherein the internal conduit is coupled at the first point to the lid portion by a second gasket and coupled at the second point to the optical fibre preform offcut by a third gasket.

11. A device according to claim 9, wherein the internal conduit is made of a transparent material.

12. A device according to claim 4, wherein one or both of the base portion and the lid portion is made of at least one of: brass, copper, stainless steel, wood, cork or plastic

13. A device according to claim 3, wherein the housing has a length of up to about 100 cm.

14. A device according to claim 2, wherein the support means comprises:
a base in which the light source is contained; and
a frame connected to the base, wherein the frame is secured to the preform offcut at one or more locations.

15. A device according to claim 1, wherein the light source is a light emitting diode (LED).

16. An illumination device, comprising:
a light source; and
a dispersing element having a plurality of refractive indices spaced apart from the light source and which receives all of the light from the light source.

17. A device according to claim 16, wherein the light source comprises a source of illumination and a shroud for directing the light.

18. A device according to claim 16, wherein the dispersing element is a crystal.

19. A system comprising a plurality of illumination devices according to claim 16.

20. An illumination device, comprising:
an optical fibre preform offcut; and
a light source arranged to output a light from within the optical fibre preform offcut.
